(19) United States
(12) Patent Application Publication
(10) Pub. No.: US 2024/0402367 A1
(43) Pub. Date: Dec. 5, 2024

(54) POSITRON RANGE CORRECTION

(71) Applicants: Siemens Medical Solutions USA, Inc., Malvern, PA (US); Ottawa Heart Institute Research Corporation, Ottawa (CA)

(72) Inventors: Michael E. Casey, Louisville, TN (US); Robert deKemp, Ottawa (CA)

(21) Appl. No.: 18/698,155

(22) PCT Filed: Apr. 24, 2023
(86) PCT No.: PCT/US2023/066102

§ 371 Date: Apr. 3, 2024

Related U.S. Application Data
(60) Provisional application No. 63/365,507, filed on May 31, 2022.

(51) Int. Cl. G01T 1/29; G06T 11/00

(52) U.S. Cl. CPC G01T 1/2985; G06T 11/006; G06T 2211/421

(57) ABSTRACT

A system and method include acquisition of emission data from an object while a radioactive tracer is present in the object, determination of first parameters of a first Gaussian distribution representing a positron range distribution of the radioactive tracer, determination of second parameters of a second Gaussian distribution associated with imaging characteristics of the imaging system, generation of a system matrix based on the first parameters and the second parameters, reconstruction of a three-dimensional image based on the emission data and the system matrix, and display of the three-dimensional image.

### CROSS-REFERENCE TO RELATED APPLICATIONS

The present application claims priority to and the benefit of U.S. Provisional Patent Application No. 63/365,507, filed May 31, 2022, the contents of which are incorporated herein by reference for all purposes.

### BACKGROUND

Tomographic reconstruction technology enables three-dimensional imaging of volumes for a variety of imaging modalities. For example, in some nuclear imaging modalities, a radioactive tracer is administered to a patient. Radioactive decay of the tracer generates positrons which travel within the patient and eventually encounter electrons. An encounter results in an annihilation event which annihilates the positron and produces two 511 keV gamma photons.

Photons emitted from the patient are detected by a detector system. A data set (i.e., emission data) representing the detected photons is provided to a tomographic reconstruction unit, which computes a three-dimensional image object based on the emission data and on characteristics of the detector system. The characteristics include but are not limited to system geometry and detector sensitivity.

In Positron Emission Tomography (PET) systems, a ring of detectors surrounding the patient detects photons emitted from the patient, identifies “coincidences” based thereon, and reconstructs PET images based on the identified coincidences using tomographic reconstruction. A coincidence is identified when two detectors disposed on opposite sides of the body detect the arrival of two photons within a particular coincidence time window.

Since an annihilation event generates two photons which travel in approximately opposite directions, the two photons arriving within the particular coincidence time window are assumed to have been produced by a same annihilation event. Moreover, the locations of the two detectors which detected the “coincident” photons define a Line-of-Response (LOR) along which the annihilation event may have occurred. The LORs defined by all the detected coincidence events are sorted into parallel projections and then used to reconstruct a three-dimensional image which represents the three-dimensional distribution of the positron-emitting tracer within the patient.

PET systems are used to produce images for determining the biochemistry or physiology of a specific organ, tumor or other metabolically-active site. The biochemistry or physiology to be determined dictates the identity of the radioactive tracer which is used. Fluorine-18 (¹⁸F) is an analog to glucose and may be used to track glucose usage. Oxygen-15 labelled water (¹⁵O-water) is an analog to water and may be used to track blood flow and organ perfusion, Gallium-68 (⁶⁸Ga) is a metal and may be used to label larger molecules such as proteins, and Rubidium-82 (⁸²R) behaves similarly to potassium and is often used for cardiac imaging.

Every radioactive tracer used in nuclear imaging emits a positron when it decays, resulting in an annihilation event. The positron travels a short distance from the nucleus from which it is produced before encountering an electron and producing 511 keV photons. The length of this short distance (i.e., the positron range) depends on the kinetic energy of the positron. In particular, the greater the kinetic energy of the positron, the more likely it will travel a greater distance before annihilation. Accordingly, the uncertainty between the location of the nucleus of the tracer molecule and the location of an annihilation event resulting from a positron emitted by the nucleus increases with increased positron energy.

If the positron range distribution is ignored during reconstruction, the resolution of the reconstructed image decreases with increased positron energy. For example, Rubidium-82 exhibits a 3.15 MeV positron energy while Fluorine-18 exhibits a 635 keV positron energy. Consequently, if positron range is not accounted for, and all else being equal, an image reconstructed based on emission data acquired using Rubidium-82 will exhibit greater blurring than an image reconstructed based on emission data acquired using Fluorine-18.

Some reconstruction techniques assume a particular positron range distribution corresponding to a particular tracer (e.g., Fluorine-18). While these techniques may produce adequate images using the particular tracer, the use of tracers having higher positron energies will result in increased image blur. Other reconstruction techniques attempt to account for the precise positron range distribution of the tracer being used, thereby requiring the execution of complex and time-consuming mathematical functions.

Systems are desired to efficiently account for the different positron range distributions of different radioactive tracers during image reconstruction.

### BRIEF DESCRIPTION OF THE DRAWINGS

FIG. 1 is a block diagram of a system to reconstruct images from emission data based on different positron range distributions of different radioactive tracers according to some embodiments;

FIG. 2 is a flow diagram of a process to reconstruct images from emission data based on different positron range distributions of different radioactive tracers according to some embodiments:

FIG. 3 illustrates generation of a point spread function (PSF) model of an imaging system according to some embodiments:

FIG. 4 illustrates determination of a Gaussian approximation of a positron range distribution according to some embodiments:

FIG. 5 illustrates differences between a positron range distribution and a Gaussian approximation of the positron range distribution according to some embodiments:

FIG. 6 illustrates combination of a PSF model of an imaging system and a Gaussian approximation of a positron range distribution to generate a combined PSF model according to some embodiments:

FIG. 7 is a tabular view of parameter values of polynomials describing PSF models of a plurality of radioactive tracers according to some embodiments:

FIG. 8 illustrates left and right sides of a PSF model associated with an imaging system and a combined PSF model according to some embodiments; and

FIG. 9 is a view of components of an imaging system according to some embodiments.

### DETAILED DESCRIPTION

The following description is provided to enable any person in the art to make and use the described embodiments and sets forth the best mode contemplated for carrying out the described embodiments. Various modifications, however, will remain apparent to those in the art.

Some embodiments modify the parameters of a PSF model used in reconstruction to correct for the positron range distribution of the relevant radioactive tracer. For example, a Gaussian distribution is determined which approximates the positron range distribution of the tracer. The Gaussian distribution is convolved with an existing Gaussian PSF model representing the system matrix of the imaging system to obtain a combined Gaussian PSF model. The combined Gaussian PSF model is used in place of the existing Gaussian PSF model for reconstruction of emission data generated using the radioactive tracer. By providing a simple Gaussian PSF model that incorporates the positron range distribution in tissue to the image reconstruction, the resultant images are deblurred (i.e., sharper with less noise) in comparison to images reconstructed based only on the existing PSF model of the imaging system.

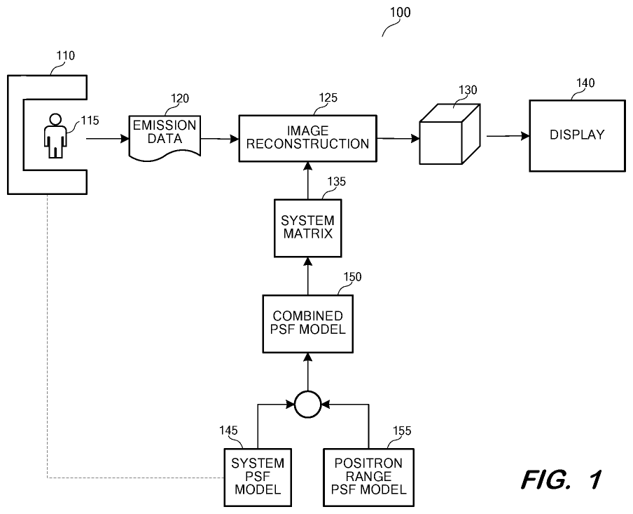

FIG. 1 illustrates system 100 according to some embodiments. Each component of system 100 and each other component described herein may be implemented using any combination of hardware and/or software. Some components may share hardware and/or software of one or more other components.

System 100 includes imaging system 110. Imaging system 110 is not limited to any particular imaging modality. For example, imaging system 110 may comprise a PET system, a PET/computed tomography (CT) system, or any other system for generating tomographic images of a subject 115 that is or becomes known.

In the case of a conventional PET-based system, a radioactive tracer is administered to subject 115 and imaging system 110 detects gamma photons emitted from subject 115 as described above. The detected gamma photons are represented within emission data 120 in any suitable format known in the art. Emission data 120 may comprise a set of projection images (i.e., two-dimensional images associated with respective projection angles showing a spatial distribution of photons detected at each angle), list mode data, sinograms, etc.

Image reconstruction component 125 calculates image object 130 based on emission data 120 and system matrix 135. System matrix 135 describes the data acquisition properties of imaging system 110. For example, system matrix 135 may model how detector element response changes based on detector element position within imaging system 110.

Image object 130 may be an N-dimensional image object (typically N=3 in medical imaging applications) and may be displayed to a user via display 140 using known volume rendering techniques. As described herein, an “image object” is defined in an object space and is a reconstruction of a data set acquired in a data space. The object space is a space in which the result of image reconstruction is defined and which corresponds to subject 115 that was imaged using imaging system 110.

Image reconstruction component 125 may implement any tomographic reconstruction algorithm that is or becomes known. Emission data acquired using PET imaging may include a low number of radiation counts and an unavoidable noise contribution. Some tomographic reconstruction algorithms are especially suited for reconstructing an object from such data sets.

Conventional image reconstruction involves a process known as back-projection. In simple back-projection, an individual data sample is back-projected by setting all the image pixels along the line of response pointing to the sample to the same value. In other words, a back-projected view is formed by smearing each view back through the image in the direction it was originally acquired. The back-projected image is determined as the sum of all the back-projected views. Regions in which back-projection lines from different angles intersect represent areas which contain a higher concentration of tracer.

The quality of reconstructed images depends on an accurate model (i.e., system matrix) of the relationship between image and projection space. The linear relationship between projection and image space is expressed as

$${p}_{j} = {\sum }_{i} {C}_{ij} {x}_{i}$$

where p is the true coincidence mean of the projection data for a given line of response (LOR) j, C is the system matrix modelling the relationship between image and projection space, and x is the image value at voxel i. The elements of the system matrix C are estimated before reconstruction and can be straightforwardly decomposed into crystal efficiencies (diagonal matrix), geometrical efficiency (diagonal matrix), and attenuation (diagonal matrix provided by CT scan).

System PSF model 145 takes into account additional blur resulting from data acquisition characteristics of imaging system 110. Basic parameters for such a PSF model 145 can be derived from data collected by imaging system 110 using a point source, e.g., as described in “Fully 3-D PET Reconstruction With System Matrix Derived From Point Source Measurements”, VY Panin et al., Institute of Electrical and Electronics Engineers (IEEE) Transactions on Medical Imaging, vol. 25, ppg. 907-921, 2006, incorporated by reference herein in its entirety. Collected data can be normalized, including with respect to geometrical and crystal components. This data collection is described in more detail below.

In prior systems such as described in Panin, system matrix 135 uses Gaussian system PSF model 145 to represent crystal and geometric efficiencies of imaging system 110. Gaussian system PSF model 145 may be parameterized and those parameters may be incorporated into system matrix 135 and used by image reconstruction component 125 to account for crystal and geometric efficiencies of imaging system 110.

According to the embodiment of the present example, system matrix 135 also models the positron range distribution of the radioactive tracer used to acquire emission data 120. Positron range PSF model 155 represents the distribution of the positron range of the tracer used to acquire emission data 120. The actual positron range distribution is typically non-Gaussian, so positron range PSF model 155 is a Gaussian approximation of the actual distribution in some embodiments to facilitate combination with Gaussian system PSF model 135. Gaussian combined PSF model 150 is generated based on Gaussian system PSF model 145 and positron range PSF model 155. Gaussian combined PSF model 150 may be parameterized and those parameters may be incorporated into system matrix 135 and used by image reconstruction component 125 in the same manner as prior systems but now accounting for both crystal and geometric efficiencies of imaging system 110 and the positron range distribution of the radioactive tracer used to acquire emission data 120.

Operator 142 may apply any operation(s) to combine positron range PSF model 155 and system PSF model 145 into combined PSF model 150. Combined PSF model 150 may comprise a model of a Gaussian distribution and may be generated by convolving positron range PSF model 155 and system PSF model 145. In some embodiments, each of positron range PSF model 155 and system PSF model 145 are represented by parameters of a polynomial, and resulting combined PSF model 150 is similarly represented by parameters of a polynomial which is incorporated into system matrix 135 and used by reconstruction component 125.

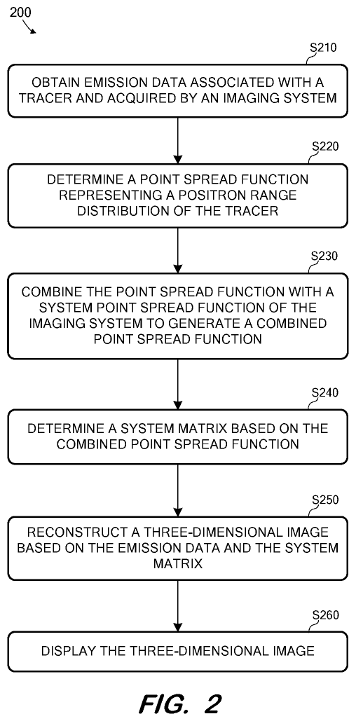

FIG. 2 is a flow diagram of process 200 to reconstruct images from emission data based on different positron range distributions of different radioactive tracers according to some embodiments. In some embodiments, various hardware elements (e.g., one or more processing units such as one or more processors, one or more processor cores and one or more processor threads) execute program code to perform process 200. The steps of process 200 need not be performed by a single device or system, nor temporally adjacent to one another or necessarily in the order shown.

Process 200 and all other processes mentioned herein may be embodied in executable program code read from one or more of non-transitory computer-readable media, such as a disk-based or solid-state hard drive, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S210, emission data associated with a radioactive tracer and acquired by an imaging system is obtained. The emission data may include a set of emission data per projection angle. The emission data acquired by a PET imaging system represents detected photon counts over a field of view and provides information regarding radioactive tracer distribution throughout aa object. The emission data may be formatted in any manner that is or becomes known (e.g., sinogram, list mode, projection images).

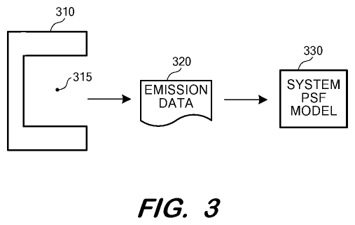

As mentioned above, the imaging system may be associated with a system PSF model as is known in the art. FIG. 3 is a block diagram illustrating determination of system PSF model 330 of imaging system 310. As shown, imaging system 310 acquires emission data 320 based on point source 315, e.g., a ⁶⁸Ge point source with a diameter of 0.5 mm and an activity of 100 μCi. Point source 315 may be positioned within system 310 using a positioning robot providing a 0.01 mm minimum step along each of three orthogonal axes. System symmetry can be leveraged by acquiring emission data 320 while point source 315 is moved within a volume that corresponds to a symmetric unit, e.g., one block of a transverse plane. Collected emission data 320 may be normalized, including with respect to geometrical and crystal components, and used to determine system PSF model 330 as described in Panin, for example.

System PSF model 330 can be separated into radial and axial components. The radial component may be assumed to be an asymmetrical function with the maximum of response in projection space at coordinate ρ₀ and combined from two half-Gaussian functions, Left and Right, which differ in their standard deviations. The PSF function for a given radial image space r coordinate of LOR and azimuthal θ can be expressed as:

$$R ( ρ ; r , θ ) = exp ( - \frac{{( ρ - {ρ}_{0} ( r ) )}^{2}}{2 {σ}_{ρ}^{2} ( ρ ; r , θ )} ) , where$$

$${σ}_{ρ} ( ρ ) = \{ \begin{matrix}\sqrt{{σ}_{left}^{2} ( r ) - {σ}_{j}^{2} ( r , θ )} , & ρ < {ρ}_{0} ( r ) \\ \sqrt{{σ}_{right}^{2} ( r ) - {σ}_{j}^{2} ( r , θ )} , & ρ \geq {ρ}_{0} ( r )\end{matrix}$$

The projection data may be parameterized by a projection radial index ρ and an azimuthal angle index θ. The parameters σ_{left}(r) and σ_{right}(r) are derived from point source measurements as described above. Parameter σⱼ(r, θ) can be estimated from point source sinogram simulation by Josephs' projector. At θ=0, this parameter has the smallest value. At θ=45°, where Joseph's method interpolation is the most prominent, this parameter will have the largest value.

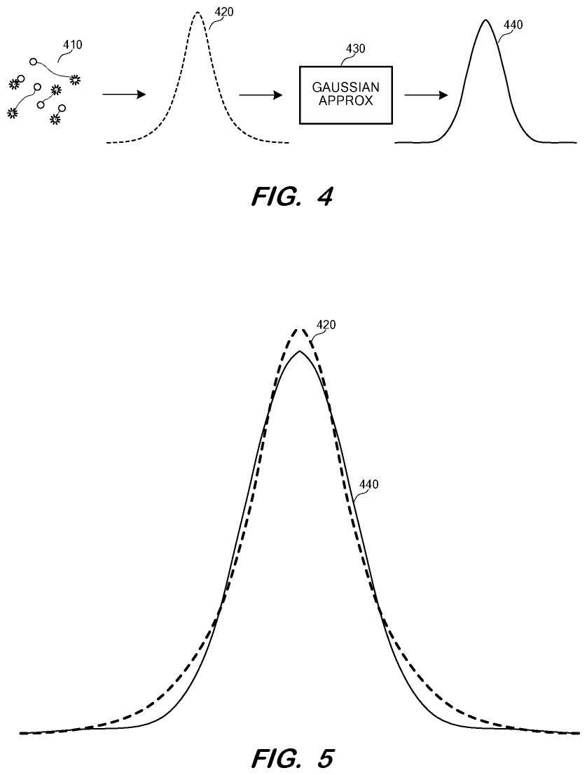

A positron range PSF model representing a position range distribution of the radioactive tracer is determined at S220. FIG. 4 includes representation 410 of positrons produced by a decaying nucleus which travel until annihilated. Each positron of representation 410 travels a particular distance prior to annihilation, and the statistical distribution of these distances can be modeled as is known in the art. Curve 420 represents one such statistical distribution for a given tracer, which is typically non-Gaussian.

At S220, Gaussian approximation component 430 generates Gaussian approximation 440 of the distribution represented by curve 420. Gaussian approximation 440 is considered the positron range PSF model. FIG. 5 overlays curve 420 and approximation 440 to illustrate differences therebetween, for example in the case of Rubidium-82. Other possible tracers include Sodium-22, as well those mentioned above.

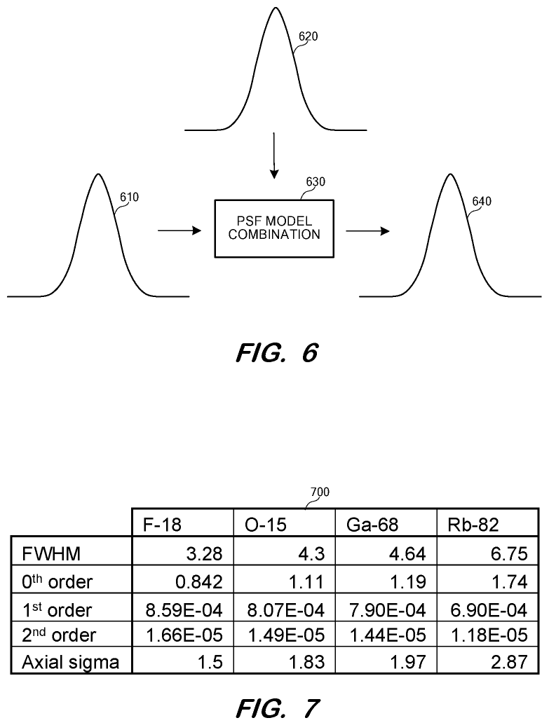

Next, at S230, the PSF model determined at S220 is combined with the system PSF model to generate a combined PSF model. The combined PSF model may comprise a model of a Gaussian distribution and may be generated by convolving the system PSF model and the positron range PSF model. FIG. 6 illustrates Gaussian positron range PSF model 610 and Gaussian system PSF model 620 combined by PSF model combination component 630 into combined PSF model 640 according to some embodiments.

Each of positron range PSF model 610 and system PSF model 620 may be represented by polynomial coefficients and/or other parameters. FIG. 7 is a representation of table 700 showing polynomial coefficients of Gaussian approximations of positron range distributions for each of four radioactive tracers. Table 700 also includes other parameters (e.g., Full Width Half Max, Axial sigma) describing the Gaussian approximations. According to some embodiments, the Gaussian approximations of positron range distributions, as well as the system PSF model, are represented by two sets of coefficients/parameters, with each set corresponding to a left or right side of the approximation. The combined PSF model may therefore also be represented by two sets of coefficients/parameters, with each set corresponding to a left or right side of the combined PSF model.

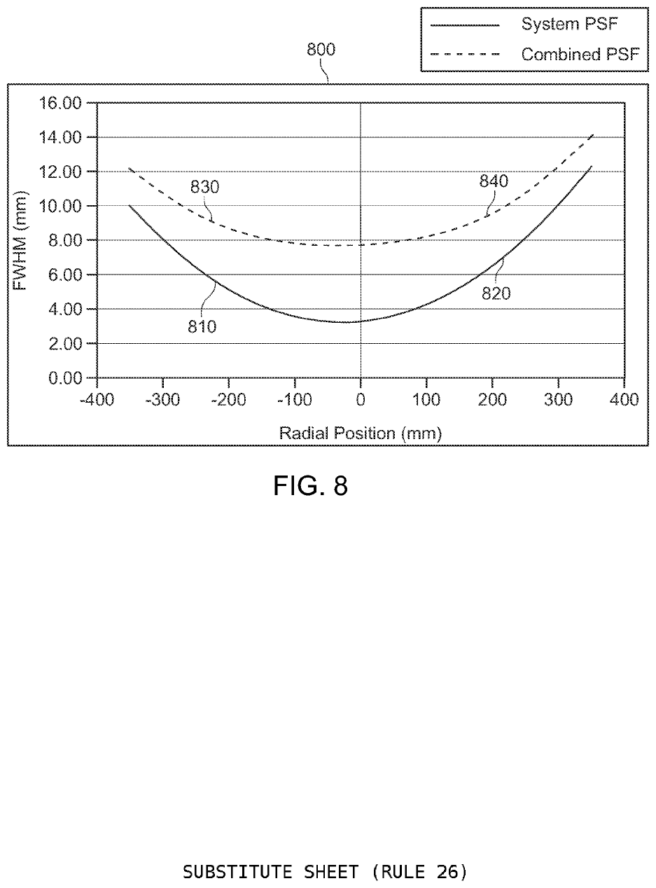

FIG. 8 illustrates the Full Width Half Max values of a system PSF model and a combined PSF model generated at S230 as a function of radial position r according to some embodiments. The system PSF model is represented as left σ 810 and right σ 820 which are each regularized by a second degree polynomial with an additional constraint of reflection symmetry with respect to r=0. Similarly, the combined PSF model is represented as left σ 830 and right σ 840 which are each regularized by a second degree polynomial with the same additional constraint.

A system matrix is determined at S240 based on the combined PSF model. In some embodiments, the coefficients of polynomial regularization are used to determine the system matrix in the same manner as described in the above-referenced article of Panin. In contrast to Panin, the coefficients of polynomial regularization incorporate both a system PSF model as described in Panin and a PSF model approximating positron range distribution of a radioactive tracer.

A three-dimensional image is reconstructed based on the emission data and the system matrix at S250. By virtue of the above-described generation of the system matrix, the reconstruction at S250 accounts for both crystal and geometric efficiencies of the imaging system and the positron range distribution of the radioactive tracer used to acquire the emission data. Accordingly, the three-dimensional image will exhibit less blur due to positron range uncertainty than prior images.

The three-dimensional image is displayed at S260. The image may be displayed via a display and using known volume rendering techniques. Such volume rendering techniques may include rendering of a perspective view of the three-dimensional image, rendering views of two-dimensional slices of the three-dimensional image, or any other techniques that are or become known.

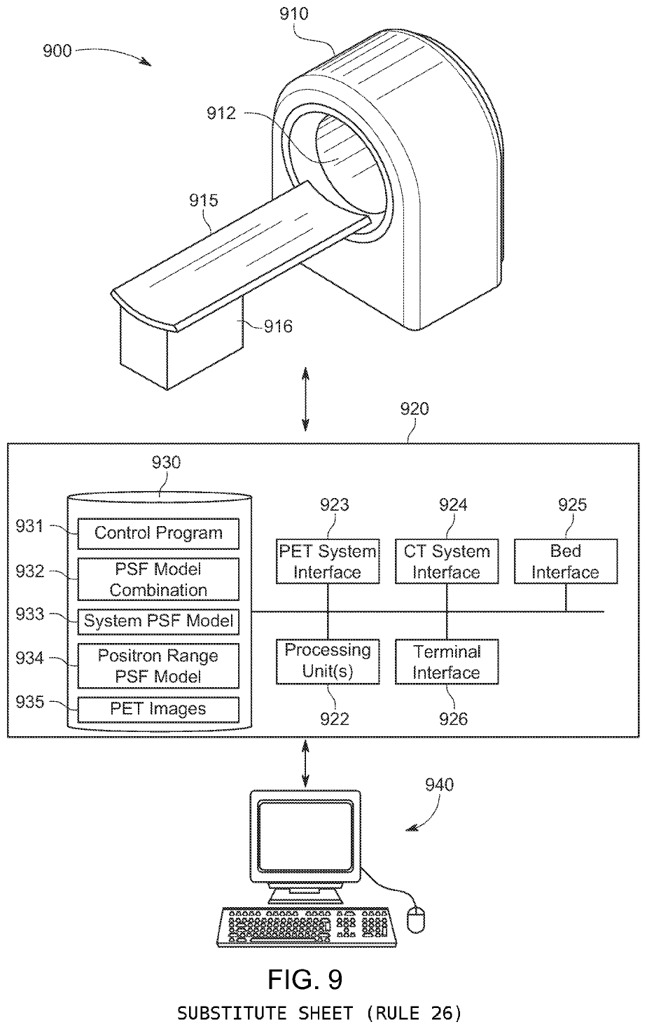

FIG. 9 illustrates PET/CT imaging system 900 to execute one or more of the processes described herein. Embodiments are not limited to system 900, to a multi-modality imaging system, or to an imaging system. For example, a system to perform process 200 on emission data may be separate from an imaging system which acquired the emission data. Moreover, the acquisition and the performance of process 200 need not be temporally adjacent.

System 900 includes gantry 910 defining bore 912. As is known in the art, gantry 910 houses PET imaging components for acquiring PET image data and CT imaging components for acquiring CT image data. The CT imaging components may include one or more x-ray tubes and one or more corresponding x-ray detectors as is known in the art. The PET imaging components may include a ring of any number or type of detectors in any configuration as is known in the art. Pulses generated by such detectors may be processed by analog and digital components as described herein to discriminate valid pulses and determine trigger times for the valid pulses.

Bed 915 and base 916 are operable to move a patient lying on bed 915 into and out of bore 912 before, during and after imaging. In some embodiments, bed 915 is configured to translate over base 916 and, in other embodiments, base 916 is movable along with or alternatively from bed 915.

Movement of a patient into and out of bore 912 may allow scanning of the patient using the CT imaging elements and the PET imaging elements of gantry 910. Bed 915 and base 916 may provide continuous bed motion and/or step-and-shoot motion during such scanning according to some embodiments.

Control system 920 may comprise any general-purpose or dedicated computing system. Accordingly, control system 920 includes one or more processing units 922 configured to execute processor-executable program code to cause system 920 to acquire image data and generate images therefrom, and storage device 930 for storing the program code. Storage device 930 may comprise one or more fixed disks, solid-state random-access memory, and/or removable media (e.g., a thumb drive) mounted in a corresponding interface (e.g., a Universal Serial Bus port).

Storage device 930 stores program code of control program 931. One or more processing units 922 may execute control program 931 to, in conjunction with PET system interface 923 and bed interface 925, control hardware elements (not shown) to inject a radioactive tracer into a patient, move the patient into bore 912 past PET detectors of gantry 910, and detect coincidences occurring within the patient based on pulses generated by the PET detectors. The detected events may be stored in storage 930 as PET data, which may comprise raw (i.e., list-mode) data and/or sinograms.

PSF model combination component may be executed to combine system PSF model 933 and positron range PSF model 934 of the tracer as described above. Control program 931 may use the resulting combined PSF model to reconstruct PET images 935 based on the acquired PET data using any suitable reconstruction algorithm that is or becomes known.

One or more processing units 922 may execute control program 931 to control CT imaging elements of system 900 using CT system interface 924 and bed interface 925 to acquire CT data. Any suitable reconstruction algorithm may be utilized to generate CT images based on the CT data. According to some embodiments, PET images 935 may be generated based at least in part on the CT data (e.g., using a linear attenuation coefficient map determined from the CT data).

PET images 935 may be transmitted to terminal 940 via terminal interface 926. Terminal 940 may comprise a display device and an input device coupled to system 920. Terminal 940 may display the received PET images 935. Terminal 940 may receive user input for controlling display of the data, operation of system 900, and/or the processing described herein. In some embodiments, terminal 940 is a separate computing device such as, but not limited to, a desktop computer, a laptop computer, a tablet computer, and a smartphone.

Each component of system 900 may include other elements which are necessary for the operation thereof, as well as additional elements for providing functions other than those described herein. Each functional component described herein may be implemented in computer hardware, in program code and/or in one or more computing systems executing such program code as is known in the art. Such a computing system may include one or more processing units which execute processor-executable program code stored in a memory system.

Those in the art will appreciate that various adaptations and modifications of the above-described embodiments can be configured without departing from the claims. Therefore, it is to be understood that the claims may be practiced other than as specifically described herein.

What is claimed is:

1. A method comprising:
obtaining emission data associated with a radioactive tracer and acquired by an imaging system;
determining first parameters of a first Gaussian distribution representing a positron range distribution of the radioactive tracer;
determining second parameters of a second Gaussian distribution associated with imaging characteristics of the imaging system;
generating a system matrix based on the first parameters and the second parameters; and
reconstructing a three-dimensional image based on the emission data and the system matrix.

2. A method according to claim 1, further comprising:
determining the positron range distribution of the radioactive tracer; and
determining the first Gaussian distribution based on the positron range distribution.

3. A method according to claim 2, wherein the positron range distribution of the radioactive tracer is not Gaussian.

4. A method according to claim 3, wherein generating the system matrix comprises convolving a first PSF model based on the first parameters with a second PSF model based on the second parameters.

5. A method according to claim 1, wherein generating the system matrix comprises convolving a first PSF model based on the first parameters with a second PSF model based on the second parameters.

6. A method according to claim 1, wherein the positron range distribution of the radioactive tracer is not Gaussian.

7. A system comprising:
an imaging system to acquire emission data from an object while a radioactive tracer is present in the object;
a processing unit to:
determine first parameters of a first Gaussian distribution representing a positron range distribution of the radioactive tracer;
determine second parameters of a second Gaussian distribution associated with imaging characteristics of the imaging system;
generate a system matrix based on the first parameters and the second parameters; and
reconstruct a three-dimensional image based on the emission data and the system matrix; and
a display to display the three-dimensional image.

8. A system according to claim 7, the processing unit to:
determine the positron range distribution of the radioactive tracer; and
determine the first Gaussian distribution based on the positron range distribution.

9. A system according to claim 8, wherein the positron range distribution of the radioactive tracer is not Gaussian.

10. A system according to claim 9, wherein generation of the system matrix comprises convolving a first PSF model based on the first parameters with a second PSF model based on the second parameters.

11. A system according to claim 7, wherein generation of the system matrix comprises convolving a first PSF model based on the first parameters with a second PSF model based on the second parameters.

12. A system according to claim 7, wherein the positron range distribution of the radioactive tracer is not Gaussian.

13. A non-transitory computer-readable medium storing program code executable by a processing unit to:
acquire emission data from an object while a radioactive tracer is present in the object;
determine first parameters of a first Gaussian distribution representing a positron range distribution of the radioactive tracer;
determine second parameters of a second Gaussian distribution associated with imaging characteristics of the imaging system;
generate a system matrix based on the first parameters and the second parameters;
reconstruct a three-dimensional image based on the emission data and the system matrix; and
display the three-dimensional image.

14. A medium according to claim 13, the program code executable by a processing unit to:
determine the positron range distribution of the radioactive tracer; and
determine the first Gaussian distribution based on the positron range distribution.

15. A medium according to claim 14, wherein the positron range distribution of the radioactive tracer is not Gaussian.

16. A medium according to claim 15, wherein generation of the system matrix comprises convolving a first PSF model based on the first parameters with a second PSF model based on the second parameters.

17. A medium according to claim 13, wherein generation of the system matrix comprises convolving a first PSF model based on the first parameters with a second PSF model based on the second parameters.

18. A medium according to claim 13, wherein the positron range distribution of the radioactive tracer is not Gaussian.
